(19) United States
(12) Patent Application Publication
(10) Pub. No.: US 2025/0086601 A1
(43) Pub. Date: Mar. 13, 2025

(54) SYSTEM AND METHOD FOR CARDED TRANSACTION PROCESSING

(71) Applicant: FSA Store Inc., Dallas, TX (US)

(72) Inventors: Bhargav Shah, Southlake, TX (US); John Paul Wilkens, Cincinnati, OH (US)

(21) Appl. No.: 18/805,202

(22) Filed: Aug. 14, 2024

Related U.S. Application Data
(60) Provisional application No. 63/581,284, filed on Sep. 8, 2023.

(51) Int. Cl. G06Q 20/08; G06Q 20/22; G06Q 20/34; G06Q 20/38; G06Q 20/40

(52) U.S. Cl. CPC G06Q 20/0855; G06Q 20/227; G06Q 20/34; G06Q 20/38215; G06Q 20/4014

(57) ABSTRACT

A method for facilitating carded transaction processing, including receiving a request for checkout, determining if a user has a carded pay third party administrator (TPA), if the user has a carded pay TPA, determining if card information is available in a private session, if the card information is not available in the private session, retrieving the card information, and directing the card information into the private session.

### CROSS-REFERENCE TO RELATED APPLICATION

This application claims the benefit under 35 U.S.C. § 119 (e) of U.S. Provisional Application No. 63/581,284, filed Sep. 8, 2023, which application is incorporated herein by reference in its entirety.

### FIELD

The present disclosure relates generally to e-commerce, and more particularly, to e-commerce transactions that do not require a user to enter payment card credentials at any time even when the card is used to complete a purchase.

### BACKGROUND

A flexible spending account (FSA), also known as a flexible spending arrangement, is one of a number of tax-advantaged financial accounts, resulting in payroll tax savings. The most common type of flexible spending account, the medical expense FSA (also medical FSA or health FSA), is similar to a health savings account (HSA) or a health reimbursement account (HRA). Paper forms or an FSA debit card may be used to access the account funds. The FSA debit card was developed to eliminate “double-dipping,” by allowing employees to access the FSA directly. It also simplified the substantiation requirement, which required labor-intensive claims processing. The debit card also enhances the effect of “pre-funding” medical FSAs. However, the substantiation requirement itself did not go away, and has even been expanded on by the Internal Revenue Service (IRS) for the debit-card environment; therefore, withdrawal issues still remain for FSAs. Current electronic commerce (E-commerce) companies have developed websites dedicated to FSA-eligible items, but fail to provide efficient transaction processing for users.

### SUMMARY

According to aspects illustrated herein, there is provided a system and method for facilitating purchase transaction processing without the need for a user to manually enter payment card information.

In an exemplary embodiment, the method comprises receiving a request for checkout, determining if a user has a carded pay third party administrator (TPA), if the user has a carded pay TPA, determining if card information is available in a private session, if the card information is not available in the private session, retrieving the card information, and directing the card information into the private session.

In an exemplary embodiment, the step of retrieving the card information comprises sending a request for card information and one or more access tokens corresponding to the user to the TPA, and validating that the one or more access tokens correspond to the user. In an exemplary embodiment, the method further comprises, prior to the step of directing the card information into the private session, determining if the card information was successfully retrieved. In an exemplary embodiment, the method further comprises determining that the card information was not successfully retrieved, and directing the user to provide an alternative payment method.

In an exemplary embodiment, the method further comprises, if the card information is available in the private session, determining if the card information in the private session is expired. In an exemplary embodiment, the method further comprises, if the card information in the private session is expired, sending a request for card information and one or more access tokens corresponding to the user to the TPA, and validating that the one or more access tokens correspond to the user. In an exemplary embodiment, the method further comprises determining if split pay is needed, and directing the user to a billing page. In an exemplary embodiment, the method further comprises deleting the card information from the private session (thus never storing or “saving” the card for future use).

According to aspects illustrated herein, there is provided a computer system for facilitating carded transaction processing, comprising one or more computer processors, one or more computer readable storage media, program instructions stored on the computer readable storage media for execution by at least one of the one or more computer processors, the program instructions comprising program instructions to receive a request for checkout, program instructions to determine if a user has a carded pay third party administrator (TPA), program instructions to, if the user has a carded pay TPA, determine if card information is available in a private session, program instructions to, if the card information is not available in the private session, retrieve the card information, and program instructions to direct the card information into the private session.

In an exemplary embodiment, the program instructions to retrieve the card information comprise program instructions to send a request for card information and one or more access tokens corresponding to the user to the TPA, and program instructions to validate that the one or more access tokens correspond to the user. In an exemplary embodiment, the program instructions further comprise program instructions to, prior to the program instructions of directing the card information into the private session, determine if the card information was successfully retrieved. In an exemplary embodiment, the program instructions further comprise program instructions to determine that the card information was not successfully retrieved, and program instructions to direct the user to provide an alternative payment method.

In an exemplary embodiment, the program instructions further comprising program instructions to, if the card information is available in the private session, determine if the card information in the private session is expired. In an exemplary embodiment, the program instructions further comprise program instructions to, if the card information in the private session is expired, send a request for card information and one or more access tokens corresponding to the user to the TPA, and program instructions to validate that the one or more access tokens correspond to the user. In an exemplary embodiment, the program instructions further comprise program instructions to determine if split pay is needed, and program instructions to direct the user to a billing page. In an exemplary embodiment, the program instructions further comprise program instructions to delete the card information from the private session.

According to aspects illustrated herein, there is provided a computer program product for facilitating carded transaction processing, comprising a computer readable storage medium and program instructions stored on the computer readable storage medium, the program instructions comprising program instructions to receive a request for checkout, program instructions to determine if a user has a carded pay third party administrator (TPA), program instructions to, if the user has a carded pay TPA, determine if card information is available in a private session, program instructions to, if the card information is not available in the private session, retrieve the card information, and program instructions to direct the card information into the private session.

In an exemplary embodiment, the program instructions to retrieve the card information comprise program instructions to send a request for card information and one or more access tokens corresponding to the user to the TPA, and program instructions to validate that the one or more access tokens correspond to the user. In an exemplary embodiment, the program instructions further comprise program instructions to, prior to the program instructions of directing the card information into the private session, determine if the card information was successfully retrieved. In an exemplary embodiment, the program instructions further comprise program instructions to determine that the card information was not successfully retrieved, and program instructions to direct the user to provide an alternative payment method.

These and other objects, features, and advantages of the present disclosure will become readily apparent upon a review of the following detailed description of the disclosure, in view of the drawings and appended claims.

### BRIEF DESCRIPTION OF THE DRAWINGS

Various embodiments are disclosed, by way of example only, with reference to the accompanying schematic drawings in which corresponding reference symbols indicate corresponding parts, in which:

FIG. 1 is a functional block diagram illustrating an environment, in accordance with some embodiments of the present disclosure.

FIG. 2 is a flow chart depicting operational steps for carded transaction processing.

FIG. 2A is a flow chart depicting operational steps for carded transaction processing.

FIG. 3 is a flow chart depicting operational steps for carded transaction processing.

FIG. 4 is a block diagram of internal and external components of a computer system, in accordance with an exemplary embodiment of the present disclosure.

### DETAILED DESCRIPTION

At the outset, it should be appreciated that like drawing numbers on different drawing views identify identical, or functionally similar, structural elements. It is to be understood that the claims are not limited to the disclosed aspects.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the claims.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “approximately” is intended to mean values within ten percent of the specified value.

It should be understood that use of “or” in the present application is with respect to a “non-exclusive” arrangement, unless stated otherwise. For example, when saying that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or a device comprising a second element and a third element.

Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or a device comprising a second element and a third element. A similar interpretation is intended when the phrase “used in at least one of:” is used herein.

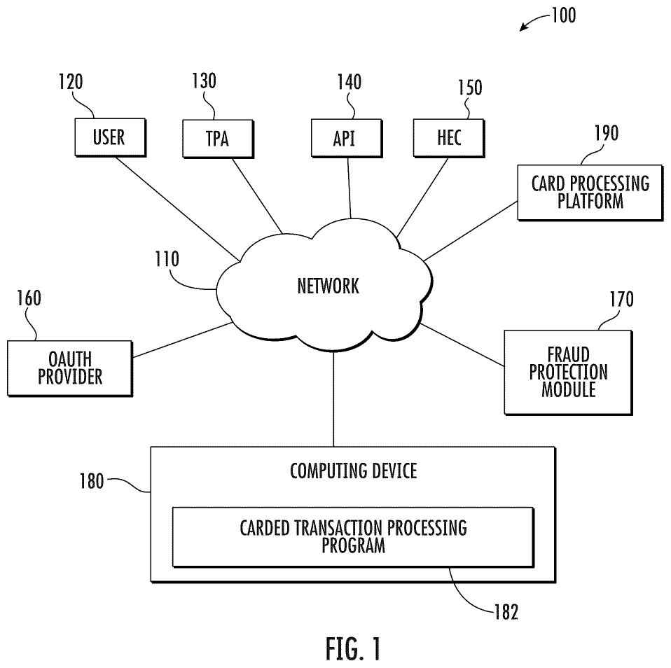

Referring now to the figures, FIG. 1 is a functional block diagram illustrating a carded transaction processing environment, generally designated 100, in accordance with one embodiment of the present disclosure. FIG. 1 provides only an illustration of one implementation, and does not imply any limitations with regard to the environments in which different embodiments may be implemented. Many modifications to the depicted environment may be made by those skilled in the art without departing from the scope of the disclosure as recited by the claims. In an exemplary embodiment, environment 100 includes user third party administrator (TPA) 130, open authentication (OAuth) provider 160, application programming interface (API) 140, health e-commerce (HEC) retailer or e-commerce retailer 150, and computing device 180 all of which are connected to network 110. In an exemplary embodiment, environment 100 further comprises fraud and chargeback prevention module 170 connected to network 110. In an exemplary embodiment, network 110 further comprises user 120 capable of communicating with network 110.

Network 110 can be, for example, a local area network (LAN), a wide area network (WAN) such as the Internet, or a combination of the two, and can include wired, wireless, or fiber optic connections.

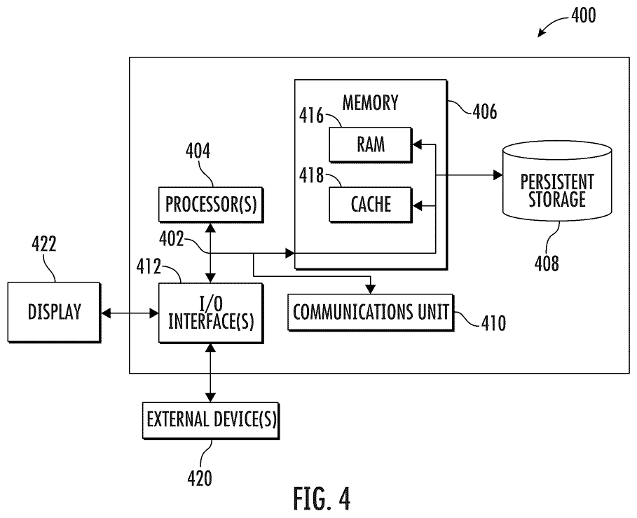

Computing device 180 may be a hardware device that receives data related to a user and communicates with various entities and components to fulfill purchase transactions without the need for the user to enter card information (e.g., FSA debit card, debit card, credit card, HSA debit card, etc.) using carded transaction processing program 182. Computing device 180 is capable of communicating with network 110, user 120, TPA 130, API 140, HEC 150, OAuth provider 160, and/or fraud detection module 170. In an exemplary embodiment, computing device 180 may include a computer. In an exemplary embodiment, computing device 180 may include internal and external hardware components, as depicted and described in further detail with respect to FIG. 4. In an exemplary embodiment, carded transaction processing program 182 is implemented on a web server, which may be a management server, a web server, or any other electronic device or computing system capable of receiving and sending data. The web server can represent a computing system utilizing clustered computers and components to act as a single pool of seamless resources when accessed through a network. In an exemplary embodiment, the web server can be hosted either in-house or with a third party cloud services provider. The web server may include internal and external hardware components, as depicted and described in further detail with respect to FIG. 4.

Carded transaction processing program 182 can coordinate input from multiple entities, for example, user 120, TPA 130, and HEC 150 and fulfill a purchase transaction for user 120 without the need for the user to manually enter in card information. Carded transaction processing program 182 can generally include any software capable of authenticating user information without the need for debit/credit card information entry, and communicating with user 120, TPA 130, API 140, HEC 150, OAuth 160, fraud protection module 170, and/or card processing platform 190 over network 110 to receive real time data from the various entities and components.

TPA 130 is an organization that administers FSA, HSA or such tax-advantaged consumer driven health plan (CDHP) accounts, processes claims or certain aspects of employee benefit plans for a separate entity. In an exemplary embodiment, TPA 130 is an FSA or HSA or similar tax advantaged CDHP account administrator.

API 130 is an application programming interface allowing two or more computer programs to communicate with each other. API 130 is a type of software interface, offering a service to other pieces of software. In an exemplary embodiment, API 130 comprises programming interfaces built using MULESOFT® integration platform.

HEC 150 is a health-E commerce retailer of products eligible for purchase using FSA, HAS, or such tax-advantaged CDHP accounts. In an exemplary embodiment, e-commerce retailer 150 is any e-commerce seller of products.

OAuth 160 is an open standard authorization protocol or framework that provides applications the ability for secure designated access. OAuth 160 doesn't share password data but instead uses authorization tokens to prove an identity between user 120 and HEC 150. OAuth 160 is an authentication protocol that allows a user to approve one application interacting with another on the user's behalf without giving away a password. Specifically, OAuth 160 authenticates the identity of user 120 via TPA 130 in order to proceed with transactions using HEC 150.

Fraud protection module 170 utilizes behavioral analysis, elastic linking, proxy detection, and/or machine learning to detect and prevent fraud and chargeback. In an exemplary embodiment, fraud protection module 170 comprises RISKIFIED® fraud protection software.

Card processing platform 190 is operatively arranged to, inter alia, offer secure, instant delivery of new or replacement card credentials to a secure application. In an exemplary embodiment, card processing platform 190 comprises Fidelity National Information Services (FIS®) financial services technology.

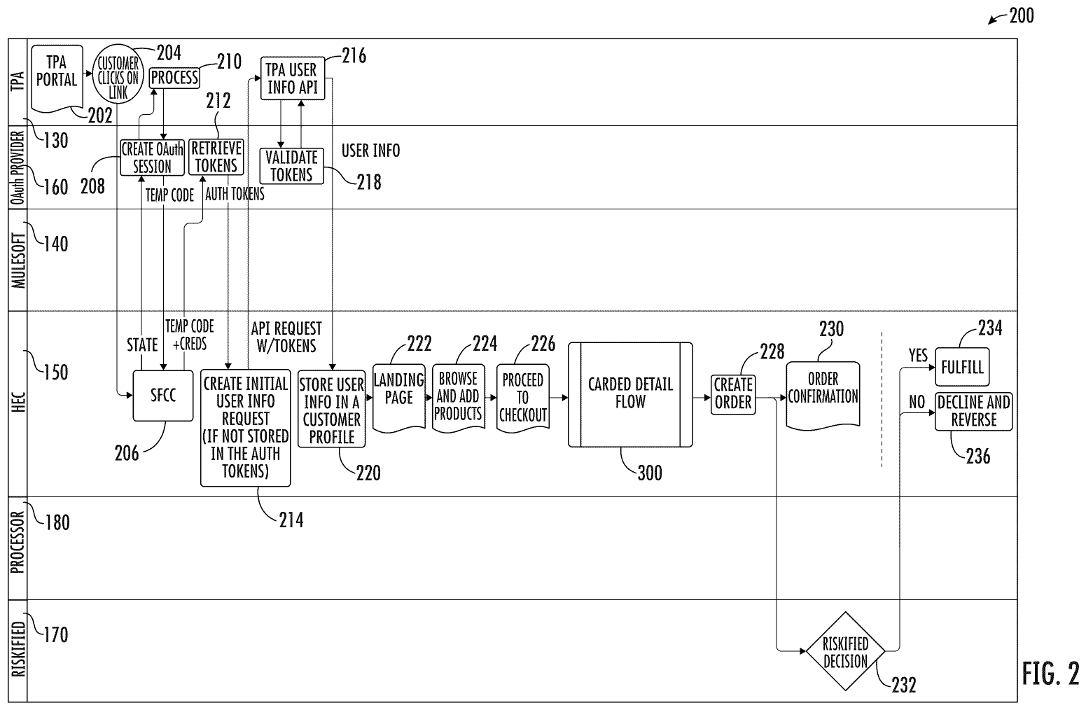

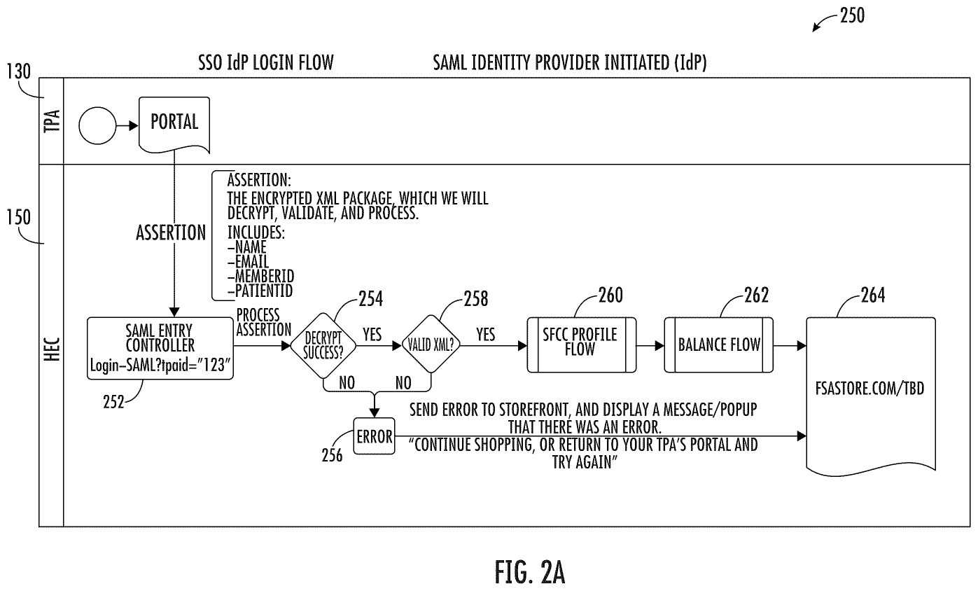

FIG. 2 shows flow chart 200 depicting operational steps for carded transaction processing.

In step 202, carded transaction processing program 182 displays TPA portal. In an exemplary embodiment, the TPA portal is displayed via TPA 130.

In step 204, carded transaction processing program 182 receives an input from user 120. For example, user 120 may click on a link presented in step 202 to provide consent and initiate the process. In an exemplary embodiment, the input submitted by user 120 occurs in the TPA portal provided by TPA 130.

In step 206, carded transaction processing program 182 sends a state generated by HEC 150 to OAuth provider 160. In an exemplary embodiment, carded transaction processing program 182 directs user 120 to an E-commerce platform that allows user 120 to access and shop on HEC 150. In an exemplary embodiment, the E-commerce platform comprises salesforce commerce cloud (SFCC). SFCC is utilized by HEC 150 to facilitate user authentication, E-commerce, and product purchases.

In step 208, carded transaction processing program 182 creates an OAuth session and generates and sends a temporary code from OAuth provider to HEC 150 (e.g., SFCC). The OAuth session is created to handle the authorization and token endpoints. Carded transaction processing program 182 uses the OAuth session to authorize devices, API 140, servers, and applications with access tokens rather than credentials. In an exemplary embodiment, in additional step 210, carded transaction processing program 182 processes the OAuth session created in step 208, for example via TPA 130. In step 210, OAuth provider 160 authenticates the connection between HEC retailer 150 and TPA 130 so that TPA 130 processes the connection request.

In step 212, carded transaction processing program 182 receives the temporary code and corresponding credentials (i.e., related to user 120) and based thereon, retrieves authentication tokens.

In step 214, carded transaction processing program 182 receives authentication tokens and creates an initial user information request. In an exemplary embodiment, the initial user information request is only created if the user information is not stored in the authentication tokens. In an exemplary embodiment, the initial user information request is generated by HEC 150.

In step 216, carded transaction processing program 182 sends the user information request (or the user information in the case where user information is stored in the authentication tokens) to TPA 130.

In step 218, carded transaction processing program 182 directs the validation of authentication tokens. In an exemplary embodiment, the authentication tokens are validated via OAuth provider 160.

In step 220, carded transaction processing program 182 directs the storage of user information in a customer profile. In an exemplary embodiment, user information is sent from TPA 130 to HEC 150.

In step 222, carded transaction processing program 182 directs user 120 to a landing page.

In step 224, carded transaction processing program 182 receives input from user 120 related to the selection of products for purchase. For example, in step 224, user 120 browses the website of HEC 150 retailer and adds products to a cart for purchase.

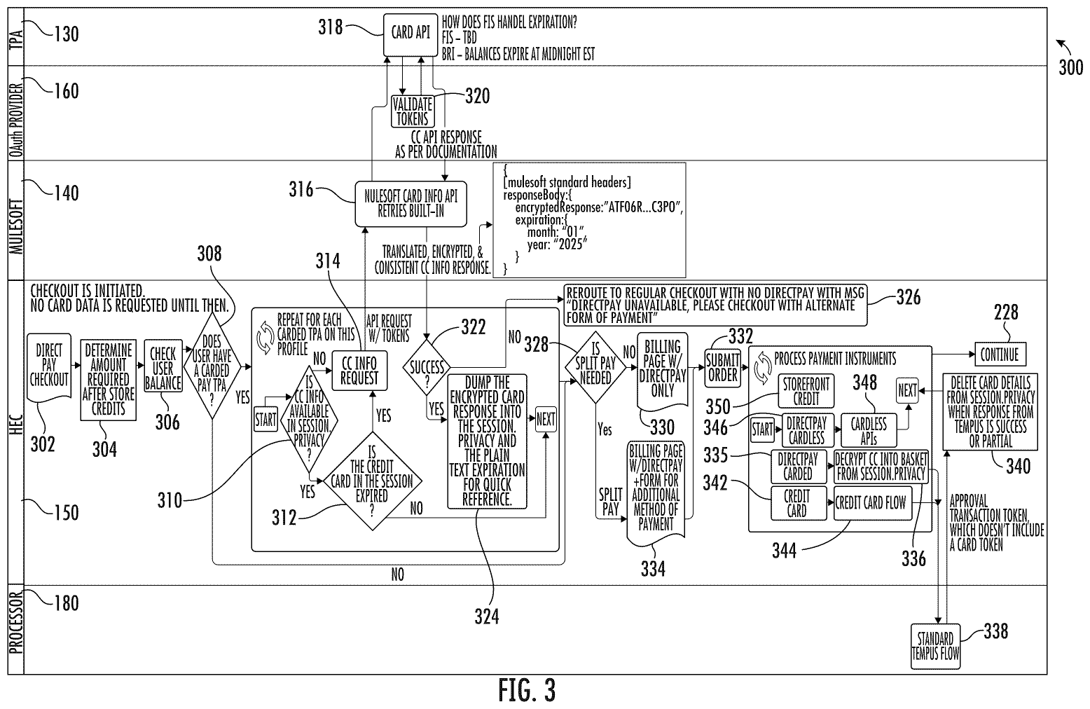

In step 226, carded transaction processing program 182 receives an input from user 120 to proceed to checkout. The process then proceeds to checkout, which is described with respect to flowchart 300 in FIG. 3, described below.

Following the checkout process, in step 228, carded transaction processing program 182 generates an order for the products purchased by user 120.

In step 230, carded transaction processing program 182 generates an order confirmation. In an exemplary embodiment, carded transaction processing program 182 displays the order confirmation and/or sends the order confirmation to user 120.

In an exemplary embodiment, following step 228, in step 232, carded transaction processing program 182 directs the created order through fraud protection module 170, which utilizes behavioral analysis, elastic linking, proxy detection, and/or machine learning to detect and prevent fraud.

If, in step 232, carded transaction processing program 182 determines that there is no fraud present, then in step 234 carded transaction processing program 182 fulfills the order and sends an order confirmation.

If, in step 232, carded transaction processing program 182 determines that there is fraud present, then in step 236 carded transaction processing program 182 declines and reverses the order. In an exemplary embodiment, carded transaction processing program 182 further notifies user 120 of the detection of fraud and/or that the order has been declined. In an exemplary embodiment, carded transaction processing program 182 further reports the existence of the detected fraud. In an exemplary embodiment, carded transaction processing program 182 further stores data indicating that fraud has been detected in association with the user information.

FIG. 2A shows flow chart 250 depicting operational steps for login flow. In an exemplary embodiment, flow chart 250 depicts operational steps for login flow via security assertion markup language (SAML), which allows identity providers (IDPs) to pass authorization credentials to service providers.

In step 252, carded transaction processing program 182 receives an input, for example, a request for login or login credentials, or an assertion. For example, user 120 may click on a link to initiate the process. In an exemplary embodiment, the input is submitted by user 120 and occurs in a TPA portal provided by TPA 130. In an exemplary embodiment, carded transaction processing program 182 directs the request to HEC 150 and/or a SAML entry controller. In an exemplary embodiment, the assertion is an encrypted extensible markup language (XML) package, which is decrypted, validated, and processed. In an exemplary embodiment, the assertion may include a name, an email, a member ID, and/or a patient ID. Carded transaction processing program 182 processes the assertion and decrypts the encrypted XML package therein.

In step 254, carded transaction processing program 182 determines if the decryption of the process assertion was successful.

If, in step 254, carded transaction processing program 182 determines that the decryption of the process assertion was not successful, then in step 256 carded transaction processing program 182 indicates an error. In an exemplary embodiment, carded transaction processing program 182 directs user 120 to a website for shopping for and purchasing items (e.g., a FSA store website) and displays a message/popup that an error has occurred. In an exemplary embodiment, carded transaction processing program 182 displays a query to the user to either 1) continue shopping, or 2) return to the TPA's portal and try login again.

If, in step 254, carded transaction processing program 182 determines that the decryption of the process assertion was successful, then in step 258 carded transaction processing program 182 determines if the assertion contains a valid XML.

If, in step 258, carded transaction processing program 182 determines that the assertion does not contain a valid XML, then in step 256 carded transaction processing program 182 indicates an error, for example as described above.

If, in step 258, carded transaction processing program 182 determines that the assertion does contain a valid XML, then in step 260 carded transaction processing program 182 proceeds to profile flow or profile authentication, and, for example, directs user 120 to an E-commerce platform (e.g., SFCC) as described above with respect to step 206 of flow chart 200, as described above with respect to FIG. 3.

In step 262, carded transaction processing program 182 proceeds to balance flow or balance authentication, and, for example, authenticates the balance of user 120 using at least one of API 140, HEC 150, OAuth provider 160, and TPA 130.

In step 264, carded transaction processing program 182 directs user 120 to a website for shopping for and purchasing items (e.g., a FSA store website). In an exemplary embodiment, the website is provided by HEC retailer 150.

FIG. 3 shows flow chart 300 depicting operational steps for carded transaction processing, namely, for the checkout process.

In step 302, carded transaction processing program 182 directs user 120 to direct pay checkout. For example, user 120 may be directed to a checkout page on HEC 150.

In step 304, carded transaction processing program 182 determines the payment amount required after any store credits have been applied (i.e., the user balance).

In step 306, carded transaction processing program 182 checks the user balance. In an exemplary embodiment, carded transaction processing program 182 checks the retrieves an updated account balance from TPA 130 and displays the account balance to user 120.

In step 308, carded transaction processing program 182 determines if user 120 has a carded pay TPA.

If, in step 308, carded transaction processing program 182 determines that user 120 has a carded pay TPA, then in step 310 carded transaction processing program 182 determines if credit/debit card information is available for user 120.

If, in step 310, carded transaction processing program 182 determines that credit/debit card information is not available for user 120, then in step 314 carded transaction processing program 182 requests credit/debit card information.

If, in step 310, carded transaction processing program 182 determines that credit/debit card information is available for user 120 from card processing platform 190, then in step 312 carded transaction processing program 182 determines if the credit/debit card information available is expired.

If, in step 312, carded transaction processing program 182 determines that the credit/debit card information available is expired, then in step 314 carded transaction processing program 182 requests credit/debit card information.

If, in step 312, carded transaction processing program 182 determines that the credit/debit card information available is not expired, then in step 328 carded transaction processing program 182 determines if split pay is needed.

If, in step 308, carded transaction processing program 182 determines that user 120 does not have a carded pay TPA, then in step 328 carded transaction processing program 182 determines if split pay is needed.

In step 316, carded transaction processing program 182 directs the credit/debit card information request from the card processing platform 190 or TPA 130 through a card info API. If the card information is not obtained for any reason from card processing platform 190 or TPA 130 then the carded transaction processing program 182 will try to get the information again through the retry pattern API.

In step 318, carded transaction processing program 182 receives the user's card information from the card processing platform 190 or TPA 130 through their card API.

In step 320, carded transaction processing program 182 obtains and uses security tokens (e.g., a bearer token or access credentials) to securely obtain the card information. In an exemplary embodiment, carded transaction processing program 182 uses the security token previously obtained as a bearer token or credentials from the TPA 130 or card procession platform 190 to request the card information securely and prevent unauthorized access to the card information.

In step 322, carded transaction processing program 182 determines if the credit/debit card information was successfully retrieved.

If, in step 322, carded transaction processing program 182 determines that the credit/debit card information was successfully retrieved, then in step 324 carded transaction processing program 182 inputs the encrypted credit/debit card information into response into a private session for quick reference. For example, carded transaction processing program 182 may place the encrypted card response into the session privacy and the plain text expiration for quick reference.

If, in step 322, carded transaction processing program 182 determines that the credit/debit card information was not successfully retrieved, then in step 326 carded transaction processing program 182 reroutes user 120 to regular checkout with no direct pay. In an exemplary embodiment, carded transaction processing program 182 may further display a message that direct pay is unavailable and direct user 120 to check out with an alternative form of payment.

If, in step 328, carded transaction processing program 182 determines that split pay is not needed, then in step 330 carded transaction processing program 182 directs user 120 to a billing page with direct pay only.

If, in step 328, carded transaction processing program 182 determines that split pay is needed, then in step 334 carded transaction processing program 182 directs user 120 to a billing page with direct pay and a form for an additional method of payment. For example, in step 334 user 120 may pay a portion of the balance using direct pay and a portion of the balance using a separate credit card.

In step 332, carded transaction processing program 182 receives an input from user 120 to submit the order.

In step 335, carded transaction processing program 182 processes the payment using a direct pay carded setting.

In step 336, carded transaction processing program 182 decrypts credit card information into a basket from the private session, for example, session.privacy.

In step 338, carded transaction processing program 182 runs the transaction through a payment processing module, which verifies the method of payment. In an exemplary embodiment, the payment processing module may comprise TEMPUS TECHNOLOGIES™ secure payment technology or similar card processing platforms. In step 338, carded transaction processing program 182 obtains approval for the payment using the card information in the basket from the private session. If the method of payment is declined, user 120 is routed to provide an alternative form of payment.

If, in step 338, carded transaction processing program 182 obtains approval from payment processing module for the method of payment, in step 340 carded transaction processing program 182 deletes credit/debit card information from the private session, for example session.privacy. The process then proceeds to step 228 wherein an order is created (refer to FIG. 2 and the description above).

It should be appreciated that other methods of payment may be used. For example, user 120 may pay with a credit or debit card by manually entering card information in steps 342 and 344. In an exemplary embodiment, user 120 may pay using store credit in step 350. In an exemplary embodiment, user 120 may pay using a direct pay carded option in steps 346 and 348, wherein credit/debit card information related to a user is not retrieved and is not necessary to complete the payment process.

FIG. 4 is a block diagram of internal and external components of computing device 400, which is representative of the computing device of FIG. 1, in accordance with an exemplary embodiment of the present disclosure. It should be appreciated that FIG. 4 provides only an illustration of one implementation and does not imply any limitations with regard to the environments in which different embodiments may be implemented. In general, the components illustrated in FIG. 4 are representative of any electronic device capable of executing machine-readable program instructions. Examples of computer systems, environments, and/or configurations that may be represented by the components illustrated in FIG. 4 include, but are not limited to, personal computer systems, server computer systems, thin clients, thick clients, laptop computer systems, tablet computer systems, cellular telephones (i.e., smart phones), multiprocessor systems, microprocessor-based systems, network PCs, minicomputer systems, mainframe computer systems, and distributed cloud computing environments that include any of the above systems or devices.

Computing device 400 includes communications fabric 402, which provides for communications between one or more processing units 404, memory 406, persistent storage 408, communications unit 410, and one or more input/output (I/O) interfaces 412. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer readable storage media. In this embodiment, memory 406 includes random access memory (RAM) 416 and cache memory 418. In general, memory 406 can include any suitable volatile or non-volatile computer readable storage media. Software is stored in persistent storage 408 for execution and/or access by one or more of the respective processors 404 via one or more memories of memory 406.

Persistent storage 408 may include, for example, a plurality of magnetic hard disk drives. Alternatively, or in addition to magnetic hard disk drives, persistent storage 408 can include one or more solid state hard drives, semiconductor storage devices, read-only memories (ROM), erasable programmable read-only memories (EPROM), flash memories, or any other computer readable storage media that is capable of storing program instructions or digital information.

The media used by persistent storage 408 can also be removable. For example, a removable hard drive can be used for persistent storage 408. Other examples include optical and magnetic disks, thumb drives, and smart cards that are inserted into a drive for transfer onto another computer readable storage medium that is also part of persistent storage 408.

Communications unit 410 provides for communications with other computer systems or devices via a network. In this exemplary embodiment, communications unit 410 includes network adapters or interfaces such as a TCP/IP adapter cards, wireless Wi-Fi interface cards, or 3G, 4G, or 5G wireless interface cards or other wired or wireless communications links. The network can comprise, for example, copper wires, optical fibers, wireless transmission, routers, firewalls, switches, gateway computers and/or edge servers. Software and data used to practice embodiments of the present disclosure can be downloaded to computing device 400 through communications unit 410 (i.e., via the Internet, a local area network, or other wide area network). From communications unit 410, the software and data can be loaded onto persistent storage 408.

One or more I/O interfaces 412 allow for input and output of data with other devices that may be connected to computing device 400. For example, I/O interface 412 can provide a connection to one or more external devices 420 such as a keyboard, computer mouse, touch screen, virtual keyboard, touch pad, pointing device, or other human interface devices. External devices 420 can also include portable computer readable storage media such as, for example, thumb drives, portable optical or magnetic disks, and memory cards. I/O interface 412 also connects to display 422.

Display 422 provides a mechanism to display data to a user and can be, for example, a computer monitor. Display 422 can also be an incorporated display and may function as a touch screen, such as a built-in display of a tablet computer.

The present disclosure may be a system, a method, and/or a computer program product. The computer program product may include a computer readable storage medium (or media) having computer readable program instructions thereon for causing a processor to carry out aspects of the present disclosure.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In an exemplary embodiment, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure are described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be appreciated that various aspects of the disclosure above and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### REFERENCE NUMERALS

100 Carded transaction processing environment
110 Network
120 User
130 Third party administrator (TPA)
140 Application programming interface (API)
150 Health-E commerce (HEC) retailer
160 Open authentication (OAuth) provider
170 Fraud protection module
180 Computing device
182 Carded transaction processing program
190 Card processing platform
200 Flow chart
202-236 Steps
250 Flow chart
252-264 Steps
300 Flow chart
302-350 Step
400 Computing device
402 Communications fabric
404 Processing units
406 Memory
408 Persistent storage
410 Communications unit
412 Input/output (I/O) interfaces
416 Random access memory (RAM)
418 Cache memory
420 External device(s)
422 Display

What is claimed is:

1. A method for facilitating carded transaction processing, comprising:
receiving a request for checkout;
determining if a user has a carded pay third party administrator (TPA);
if the user has a carded pay TPA, determining if card information is available in a private session;
if the card information is not available in the private session, retrieving the card information; and
directing the card information into the private session.

2. The method as recited in claim 1, wherein the step of retrieving the card information comprises:
sending a request for card information and one or more access tokens corresponding to the user to the TPA; and
validating that the one or more access tokens correspond to the user.

3. The method as recited in claim 1, further comprising:
prior to the step of directing the card information into the private session, determining if the card information was successfully retrieved.

4. The method as recited in claim 3, further comprising:
determining that the card information was not successfully retrieved; and
directing the user to provide an alternative payment method.

5. The method as recited in claim 1, further comprising:
if the card information is available in the private session, determining if the card information in the private session is expired.

6. The method as recited in claim 5, further comprising:
if the card information in the private session is expired, sending a request for card information and one or more access tokens corresponding to the user to the TPA; and
validating that the one or more access tokens correspond to the user.

7. The method as recited in claim 1, further comprising:
determining if split pay is needed; and
directing the user to a billing page.

8. The method as recited in claim 1, further comprising:
deleting the card information from the private session.

9. A computer system for facilitating carded transaction processing, comprising:
one or more computer processors;
one or more computer readable storage media;
program instructions stored on the computer readable storage media for execution by at least one of the one or more computer processors, the program instructions comprising:
program instructions to receive a request for checkout;
program instructions to determine if a user has a carded pay third party administrator (TPA);
program instructions to, if the user has a carded pay TPA, determine if card information is available in a private session;
program instructions to, if the card information is not available in the private session, retrieve the card information; and
program instructions to direct the card information into the private session.

10. The computer system as recited in claim 9, wherein the program instructions to retrieve the card information comprise:
program instructions to send a request for card information and one or more access tokens corresponding to the user to the TPA; and
program instructions to validate that the one or more access tokens correspond to the user.

11. The computer system as recited in claim 9, wherein the program instructions further comprise:
program instructions to, prior to the program instructions of directing the card information into the private session, determine if the card information was successfully retrieved.

12. The computer system as recited in claim 11, wherein the program instructions further comprise:
program instructions to determine that the card information was not successfully retrieved; and
program instructions to direct the user to provide an alternative payment method.

13. The computer system as recited in claim 9, wherein the program instructions further comprising:
program instructions to, if the card information is available in the private session, determine if the card information in the private session is expired.

14. The computer system as recited in claim 13, wherein the program instructions further comprise:
program instructions to, if the card information in the private session is expired, send a request for card information and one or more access tokens corresponding to the user to the TPA; and
program instructions to validate that the one or more access tokens correspond to the user.

15. The computer system as recited in claim 9, wherein the program instructions further comprise:
program instructions to determine if split pay is needed; and
program instructions to direct the user to a billing page.

16. The computer system as recited in claim 9, wherein the program instructions further comprise:
program instructions to delete the card information from the private session.

17. A computer program product for facilitating carded transaction processing, comprising:
a computer readable storage medium and program instructions stored on the computer readable storage medium, the program instructions comprising:
program instructions to receive a request for checkout;
program instructions to determine if a user has a carded pay third party administrator (TPA);
program instructions to, if the user has a carded pay TPA, determine if card information is available in a private session;
program instructions to, if the card information is not available in the private session, retrieve the card information; and
program instructions to direct the card information into the private session.

18. The computer program product as recited in claim 17, wherein the program instructions to retrieve the card information comprise:
program instructions to send a request for card information and one or more access tokens corresponding to the user to the TPA; and
program instructions to validate that the one or more access tokens correspond to the user.

19. The computer program product as recited in claim 17, wherein the program instructions further comprise:
program instructions to, prior to the program instructions of directing the card information into the private session, determine if the card information was successfully retrieved.

20. The computer program product as recited in claim 19, wherein the program instructions further comprise:
program instructions to determine that the card information was not successfully retrieved; and
program instructions to direct the user to provide an alternative payment method.
